(19) United States
(12) Patent Application Publication
(10) Pub. No.: US 2021/0097634 A1
(43) Pub. Date: Apr. 1, 2021

(54) SYSTEMS AND METHODS FOR SELECTING A TRAINING PROGRAM FOR A WORKER

(71) Applicant: NICE LTD., Ra'anana (IL)

(72) Inventors: David Geffen, Givat Shmuel (IL); Yuval SHACHAF, Even Yehuda (IL); Gennadi LEMBERSKY, Haifa (IL)

(73) Assignee: NICE LTD., Ra'anana (IL)

(21) Appl. No.: 16/583,303

(22) Filed: Sep. 26, 2019

(51) Int. Cl. G06Q 50/20; G06Q 10/06

(52) U.S. Cl. CPC G06Q 50/2057; G06Q 10/063114; G06Q 10/06393

(57) ABSTRACT

A system and method for selecting a training program from a plurality of training programs for a selected worker may include evaluating performance improvement of a plurality of workers who have taken training programs of the plurality of training programs, and associating a performance improvement grade to each of the workers for each of the training programs the worker has taken; selecting, in a worker database, workers that are similar to the selected worker; and selecting the training program for the selected worker based on the performance improvement grades associated with the similar workers for the plurality of training programs.

### FIELD OF THE INVENTION

The present invention relates generally to selecting a training program for a worker, based on performance improvement of similar workers, for use for example in workplaces, such as contact centers.

### BACKGROUND

Workplaces such as contact centers may provide coaching or training programs to agents, workers or employees that do not meet their goals. Training programs may include one-on-one sessions, in which the supervisor or another professional teaches or provides training material to the worker. For example, in contact centers, a supervisor may provide the employee with a recording of one or more interactions, either of the agent or of other agents, and request the agent to listen and/or view the interactions in order to learn how to better perform in the future.

While this is the standard form of coaching agents in contact centers today, this method does not always provide good results. Some agents respond well to this method of coaching while others do not. There are additional ways to coach an agent such as: group coaching, e.g., teaching multiple agents in a single session managed by a supervisor or other professional, online learning, e.g., providing an agent with links to knowledge centers and materials on the internet or intranet, peer coaching e.g., studying with a colleague, trivia, e.g., questions for learning a subject, etc. Different agents may respond differently to each method. While some workers may benefit from online learning, others may gain more from group coaching. Even in the case of standard one-one-one coaching, different agents may respond differently to different people coaching them.

### SUMMARY

According to embodiment of the invention, a system and method for selecting a training program from a plurality of training programs for a selected worker may include, using a technology platform including one or more computer systems, evaluating performance improvement of a plurality of workers who have taken training programs of the plurality of training programs, and associating a performance improvement grade to each of the workers for each of the training programs the worker has taken; selecting, in a worker database, workers that are similar to the selected worker; and selecting the training program for the selected worker based on the performance improvement grades associated with the similar workers for the plurality of training programs.

According to embodiments of the invention, evaluating performance improvement of a plurality of workers may include, for the plurality of workers: providing at least one training program to a worker of the plurality of workers; and for each of the at least one training programs, measuring performance of the worker before and after taking a provided training program, and calculating a performance improvement grade for the worker based on the performance measured before and after taking the provided training program.

According to embodiments of the invention, for a worker, the performance improvement grade associated with a training program may be an improvement of a performance of the worker after taking the training program, relative or compared to a performance of the worker before taking the training program.

According to embodiments of the invention, selecting the training program may include: calculating a total performance improvement grade for each of the at least one training programs, based on the performance improvement grades associated with the similar workers in each of the at least one training programs; and selecting the training program with the maximal total performance improvement grade.

According to embodiments of the invention, selecting the training program may include: calculating a total performance improvement grade for each of the at least one training programs, based on the performance improvement grades associated with the similar workers in each of the at least one training programs; associating a cost value with each training program; normalizing the total performance improvement grade associated with each training program by the cost value of the training program; and selecting the training program with the maximal normalized performance improvement grade associated with the similar workers.

Embodiments of the invention may include storing in the worker database a record for each worker, the record comprising a plurality of attributes of the worker.

According to embodiments of the invention, finding similar workers in the worker database may be performed based on the attributes of the workers.

According to embodiments of the invention, finding similar workers in the worker database may be performed by calculating a similarity score between the worker and other workers in the database; and selecting workers with the highest similarity score.

According to embodiments of the invention, selecting the training program may include: calculating the total performance improvement grade for a training program of the at least one training programs as a weighted average of the performance improvement grades associated with the similar workers in the training program, wherein the weights are normalized similarity scores of the similar workers.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 schematically illustrates a system, according to embodiments of the invention;

FIG. 2 is a flowchart of a method for selecting a training program from a plurality of training programs for a worker, according to embodiments of the invention;

FIG. 3, is a flowchart of a method for selecting a worker to be trained, according to embodiments of the invention;

FIG. 4 depicts a first screenshot example, according to embodiments of the invention;

FIG. 5 depicts a second screenshot example, according to embodiments of the invention;

FIG. 6 depicts a third screenshot example, according to embodiments of the invention; and

FIG. 7 illustrates an example computing device according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

Contact centers may include many agents or other people or personnel available to participate in contacts with customers. A contact may be, for example, a conversation or interaction between an agent and a customer. The contact center may house many more agents than supervisors. For example, in many contact centers a single supervisor may be responsible for a team of up to 25 agents or more. In addition, turnover in contact centers may be high, e.g., between 30-45 percent (e.g., 30-45% of agents change within one year), so there may be a constant flow of employees that need training. The supervisors may find it difficult to effectively train every agent often enough. Although a contact center may staff more supervisors to coach more agents, doing so may be relatively costly. For example, staffing more supervisors may increase the costs of operating the contact center, including supervisor salary costs and supervisor workspace costs, without a fully offsetting increase in revenue. While embodiments of the invention are described herein with relation to agents in a contact center, embodiments of the invention may be useful for computer systems in other organizations with supervisors and workers or agents (the terms agents and workers or employees will be used interchangeably herein).

Furthermore, while one-on-one sessions may be a default form of coaching in many organizations, this method does not always provide good results. Some agents may respond well to this method of coaching while others may not. Therefore, organizations may develop other ways to coach an agent such as: group coaching, e.g., teaching multiple agents in a single session managed by a supervisor or other professional, online learning, e.g., providing an agent with links to knowledge centers and materials on the internet or intranet, peer coaching e.g., studying with a colleague, trivia, e.g., questions for learning a subject, etc. Facing this variety of training programs, the supervisor needs to decide which training program should be provided to an agent that needs training. The cost of each training programs may be different, and individual agents may respond differently to each training program. Thus, the supervisor may not know which training program may be the most efficient for a specific agent, both in terms of cost and in terms of improving performance. Thus, organizations may invest time and money in coaching but may not necessarily provide the right type of coaching to the right agent. This may waist money and have a negative effect on productivity and employee engagement.

Embodiments of the invention may provide computing systems selecting or aiding in the selection of a training program from a number of training programs for a selected worker. Organizations today can measure the effect of a training program on the performance of workers that participated in the training program. According to embodiments of the invention, these measurements may be used for providing a recommendation for selecting a training program for a specific worker. Furthermore, the recommendation may be provided based on performance improvement data of workers that are similar to the specific worker. Embodiments of the invention may be further refined to select training programs that had the best effect on a specific metric or key performance indicator (KPI) in the past, to select the most suitable supervisor to provide the training program, the most cost effective training program, etc., all based on performance improvement data gathered by the organization based on the results of former training programs that were given to similar workers. Thus, embodiments of the invention may increase the efficiency of training programs provided to workers and by this may save costs, improve employee professionalism and engagement, and eventually increase customer satisfaction.

Although described in the context of a contact center, the same or a similar system may be employed in other contexts where coaching of large numbers of people may be beneficial. For example, embodiments of the system and method for selecting a training program may be employed on a stock exchange floor, at a factory, or the like.

Reference will be made to the figures wherein like structures will be provided with like reference designations. The drawings are non-limiting, diagrammatic, and schematic representations of example embodiments, and are not necessarily drawn to scale.

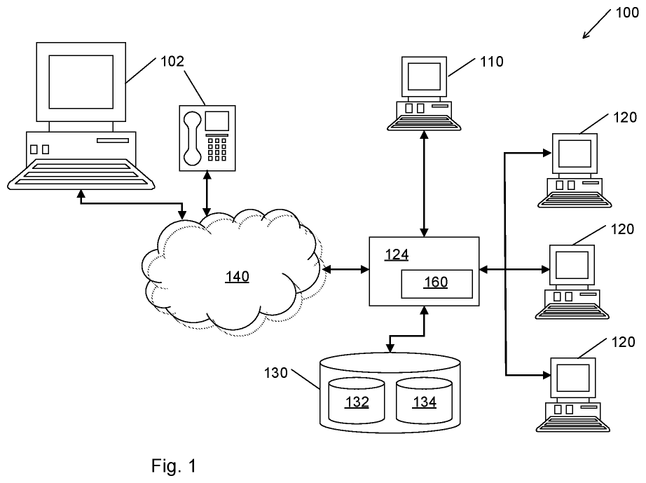

Reference is made to FIG. 1, which schematically illustrates a system 100, according to embodiments of the invention. System 100 may include contact center 124 which may connect customer devices 102 to agent devices 120. Contact center 124 may also be connected to supervisor device 110. Contact center 124 may be or may include company call centers for telephone-based support, or online support forums for voice over internet protocol (VoIP) Internet-based support, for example, to provide customers with technical support, sell products, schedule appointments, or otherwise interact or communicate with customers. Organizations other than a contact center may use embodiments of the invention. Contact center 124 may include a switching station to connect each of a plurality of user devices 102 to one of a plurality of agent devices 120 at the same time. Contact center 124 may include recommender engine 160 configured to select a training program from a plurality of training programs for a worker as disclosed herein. Contact center 124 may be connected to one or more databases 130 for storing interactions or calls (e.g. conversations via telephone, VoIP, etc.) between users and agents via user devices 102 and agent's devices 120, and other data such as agents' attributes, performance improvement grades of workers, training programs, costs of training programs, and any other relevant data.

In some embodiments one or more databases 130 may include a worker profile database or worker database 132 and a performance improvement database 134. Worker database 132 may store attributes of workers, e.g., in a multi-column table format. The worker attributes may be used for finding a group of similar workers given a specific worker. The attributes may include any characteristic of or describing the workers that may be used for categorizing or clustering workers and finding similar workers. The attributes may include for example, an agent's soft skills, relevant contact center statistics and an agent's attributes. For example, agent's soft skills may include ranks or grades for the agent' s communication skills, problem solving, professionalism, creativity, etc., the agent attributes may include tenure, fields of expertise, languages, education, age, etc., and contact center statistics may include working shifts, average handle time, average call sentiment, transfer rate etc. Other attributes may be used. An example of worker database 132 is provided in Table 1. Each column represents an attribute and each row represents a worker. The table cells include the grades or scores of each worker in each attribute.

TABLE 1
An example for a worker database.

| | Skill | Skill | | | | Tenure | | | |
|---|---|---|---|---|---|---|---|---|---|
| Agent | #1 | #2 | . . . | Languages | Creativity | months | Education | Age | . . . |
| 1 | 1 | 0 | | EN | 5 | 11 | High School | 34 | |
| 2 | 1 | 1 | | EN | 1 | 34 | Undergrad | 20 | |
| 3 | 0 | 0 | | EN, ES | 4 | 23 | Undergrad | 23 | |
| 4 | 0 | 1 | | ES | 1 | 18 | Undergrad | | |
| . . . | | | | | | | | | |
| N | 1 | 1 | | EN, FR | 0 | 4 | None | 41 | |

Performance improvement database 134 may include performance improvement grades of workers achieved by taking training programs. According to some embodiments, performance improvement database 134 may include the measured performance improvement of agents or workers after taking training programs, per worker, per training program and per KPI.

System 100 may be connected, or configured to be connected, to one or more user devices 102, such as, computers (for web or Internet voice connections), telephones (for telephone or radio network connections), for a customer to interact with and communicate with agents over one or more networks 140. Networks 140 may include any type of network or combination of networks available for supporting communication between user devices 102, supervisor device 110, contact center 124, agent devices 120 and databases 130. Networks 140 may include for example, wired and wireless telephone networks, the Internet and intranet networks, etc. Customers may use user devices 102 to connect to and communicate with live agents, for example, using or operating on agent devices 120 at contact center 124. System 100 may be connected, or configured to be connected, to one or more supervisor devices 102, such as, a computer for supervising agents.

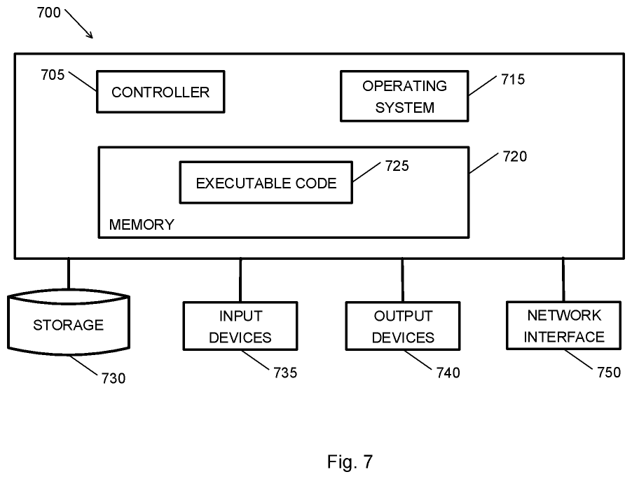

Each of user devices 102, supervisor device 110, contact center 124 and agent devices 120 may be or may include a computing device such as computing device 700 depicted in FIG. 7. One or more database 130 may be or may include a storage device such as storage device 730.

Recommender engine 160 may be configured to evaluate performance improvement of a plurality of workers who have used training programs, and associate a performance improvement grade to each of the workers for each of the training programs the worker has taken or participated in, select workers that are similar to a worker that needs training, and select the training program for the worker that needs training based on the performance improvement grades associated with the similar workers for the plurality of training programs.

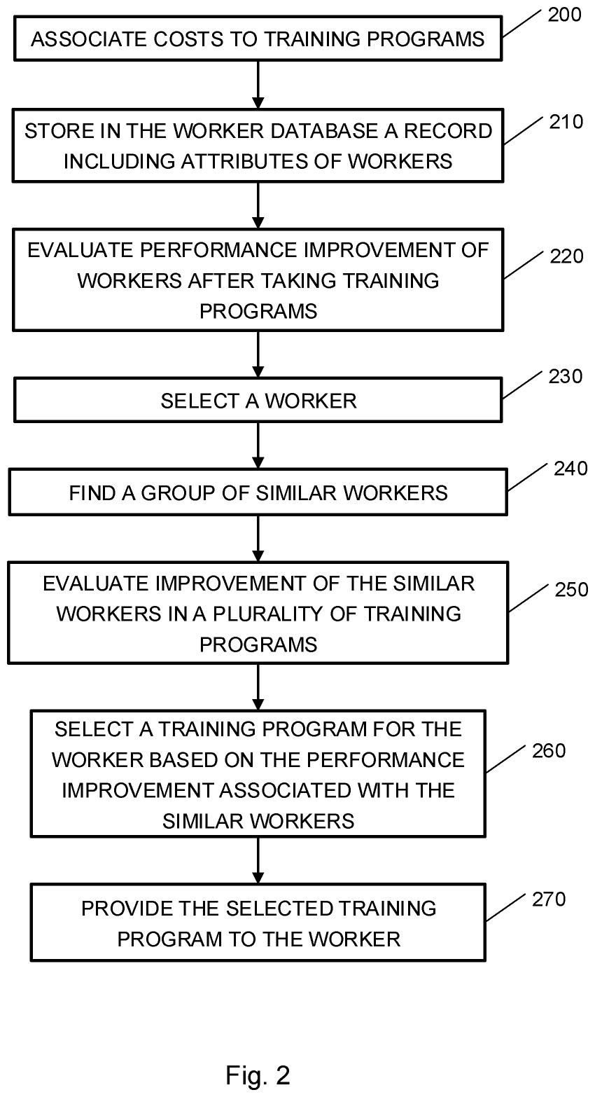

Reference is made to FIG. 2, which is a flowchart of a method for selecting a training program from a plurality of training programs for a worker, according to embodiments of the invention. An embodiment of a method for selecting a training program from a plurality of training programs for a worker may be performed, for example, by the systems shown in FIG. 1, but other hardware may be used.

In operation 200, a cost value may be associated with each training program, for example by recommender engine 160. The cost value may equal or may be calculated based on the number of tasks in a training program, the duration of the training program, the actual or estimated price of the training program, etc., and any combination thereof. For example, in some embodiments training programs may include tasks, such as one-on-one training, online training, group training, trivia, etc. A training program may include one or more of these tasks. For example, a first training program may include a one-on-one session with a supervisor, a second training program may include group training, and a third training program may include the combination of the one-on-one session with a supervisor and the group training. Thus, in some embodiments, each of a first portion of the training programs may include a single task of a set of tasks and each of a second portion of the training programs may include a combination of at least two single tasks of the set of tasks. The cost value may be or may be based on the number of tasks in the training program. It is noted that the training programs may include several different tasks of the same type. For example, the training programs may include more than one one-on-one training programs, each with a different professional. Each of these one-on-one training programs may have the same or different cost value.

For example, in the case of four tasks, e.g., trivia, one-on-one, group coaching and call listening, the maximal number of training programs (e.g., the number of combinations of these tasks) may be calculated by:

$$number of tasks combinations = {\sum }_{m = 0}^{n} ( \begin{matrix}n \\ m\end{matrix} ) = ( \begin{matrix}4 \\ 1\end{matrix} ) + ( \begin{matrix}4 \\ 2\end{matrix} ) + ( \begin{matrix}4 \\ 3\end{matrix} ) + ( \begin{matrix}4 \\ 4\end{matrix} ) = 15 \qquad ( Equation 1 )$$

Where n is the number of tasks, n=4, and m is the number of tasks in a training program, and the size of a set of all k-length combinations selected from a set S is denoted

$$( \begin{matrix}S \\ k\end{matrix} ) .$$

The cost value of each of the training programs may equal the number of tasks in the training program, e.g., m, the combined price or time duration of the combination of the tasks, etc.

In operation 210, a record for each worker may be stored, e.g., in a worker database such as worker database 132. For example, recommender engine 160 may generate and store a record for each worker in worker database 132. The record may include one or more attributes of the worker. The attributes may include any characteristic of the workers that may be used for categorizing or clustering workers and finding similar workers, as disclosed herein.

In operation 220, the performance improvement of workers who have taken or participates in a training programs may be evaluated, measured or calculated, for example by recommender engine 160. A performance improvement grade may be associated to each of the workers for each of the training programs the worker has taken. Evaluating the performance improvement of workers may include providing at least one training program to one or more workers. The performance of the one or more workers may be measured before and after taking each of the provided training program. For example, measuring the performance of a worker may include measuring, calculating or estimating metrics. Some metrices may be measured and computed automatically by the system, e.g., by for example contact center 124. Metrices that are measured automatically may include a sentiment score, an empathy score, transfer rate, and others. Other metrics, such as self-assessment score may require manual evaluation by the agent or the supervisor. Thus, contact center 124 may obtain some metrices form a user.

A performance improvement grade may be calculated for each worker, for each of the training programs that the worker has taken, based on the performance measured after taking the provided training program, relative or compared to a performance of the worker measured before taking the training program. In some embodiments, the performance of the one or more workers may be measured per KPI. For example, KPIs may include a “Team Employee Engagement” KPI that may be a combination of six metrices including for example: a sentiment score, an empathy score, a transfer rate, an adherence to schedule score, revenue per contact and self-assessment score. Other KPIs may be used. A worker may be evaluated and provided with a set of scores, e.g., a score for each of a number of KPIs. Then, the worker may take part in a training program. After some time, the worker may be evaluated again, and provided with a second set of scores, e.g., a second score for each of a number of KPIs. The performance improvement of the worker may be evaluated, estimated or calculated based on the differences or the relation (e.g., a percent improvement may be calculated) between the second set of scores and the first set of scores. For example, a general performance improvement grade or score may be estimated or calculated for the worker, and/or a plurality of performance improvement grades or scores may be estimated or calculated, one for each KPI.

In the case that some of the training programs include a single task and others include a combination of these tasks, the performance improvement of the worker may be evaluated, estimated or calculated for each task. The performance improvement of the combination of tasks may be a combination of the performance improvement of the tasks that are included in the training program. Table 2 presents example performance improvements of workers after taking training programs including one or more tasks. Table 2 provides performance improvement of workers or performance improvement of workers per KPI; other measures may be used. The rows in table 2 represent workers and the columns represent the training programs. The cells provide the percent improvement for a worker after taking a training program. Cells with “None” represent a training program that was not taken by the worker. Similarity scores, S, are listed in the last column.

TABLE 2
performance improvement of workers after taking
training programs including one or more tasks.

| | | | | | | | | |
|---|---|---|---|---|---|---|---|---|
| | | | | Call | 1:1, | 1:1, Trivia, | | Similarity |
| Agent | session | 1:1 | Trivia | Listening | Trivia | Call Listening | . . . | Score S |

| | | | | | | |
|---|---|---|---|---|---|---|
| 1 | None | None | None | None | None | |
| 2 | +1% | +2% | +1% | +3% | +4% | 0.9 |
| 3 | +2% | +1% | 0% | +3% | +3% | 0.8 |
| 4 | None | None | +1% | None | None | 0.6 |
| . . . | | | | | | |
| N | +2% | +1% | +3% | +3% | +6% | 0.1 |

In operation 230, a worker may be selected or chosen. For example, the worker may be selected by a supervisor and the selection may be provided to recommender engine 160, or the worker may be selected automatically by, for example recommender engine 160. The worker may be selected randomly, according to training schedule or based on criteria. The performance of workers or agents may be evaluated. The criteria may be related the measures performance. For example, workers that do not reach a performance goal that is expected from them, or workers with performance that is below a threshold in one or more KPIs, may be selected. In some embodiments, an alert may be generated or obtained in case of a decrease in a KPI in a group of workers, and the worker that contributes the most to the decrease in the KPI may be selected. Other method for selecting workers and other criteria may be used.

In operation 240, a group of similar workers may be selected. For example, recommender engine 160 may select a group of similar workers from worker database 132 based on the attributes of the workers stored in worker database 132. The group of similar workers may include workers other than the selected worker, that are similar to the selected worker, for example based on a set of attributes or characteristics. Similarity may be evaluated based on the workers' attributes, e.g., workers having common or close qualities or characteristics as the selected worker. The group of similar workers may be selected from the company workers using any suitable criteria and/or similarity function such as cosine similarity.

In some embodiments, similarity scores (e.g., cosine similarity scores) may be calculated between the selected worker and each of the other workers. The group of similar workers may be selected based on the similarity scores, e.g., a number of workers having the highest similarity score or workers with similarity score above a threshold may be included in the group of similar workers. Other criteria for selecting similar workers may be used. For example, in table 1, the similar workers for worker no. 1 are workers no. 2-4.

According to some embodiments, similarity scores between each worker and the rest of the workers may be calculated offline and arranged in a half similarity matrix. An example half similarity matrix is presented in Table 3. The rows and columns of the half similarity matrix represent agent (e.g. worker) i and agent j, respectively, where i and j are agent indices i,j=1,2 . . . , N, where N is the number of workers. Cells represent the similarity scores between agent i and agent j. Similarity scores are then calculated and stored. The cosine similarity score may be calculated for example as follows:

For i in 1 to num_of agents-1:

For j in i+1 to num_of agents:
Agent_similarity: S[ij]=cosine similarity(agent[i], agent[j])

TABLE 3
a half similarity matrix showing similarity scores between workers.

| | | | | | | |
|---|---|---|---|---|---|---|
| Agent i | Agent j | 1 | 2 | 3 | . . . | N |

| | | | | | |
|---|---|---|---|---|---|
| 1 | 1 | 0.9 | 0.4 | 0.2 | 0.1 |
| 2 | | 1 | 0.8 | 0.3 | 0.4 |
| 3 | | | 1 | 0.8 | 0.9 |
| . . . | | | | 1 | 0.6 |
| N | | | | | 1 |

In some embodiments, similarity scores may be calculated, sorted and stored in a descending order for each agent offline. Subsequently, this will allow fetching in runtime, for example, the top q similar agents in constant time and complexity. In some embodiments, the similarity scores may be normalized, e.g., by dividing each score by the sum of scores of the top q similar agents.

In operation 250, a total or joint performance improvement grade, combining the performance improvement grades of the similar workers, may be evaluated, estimated or calculated for each of the at least one training programs, based on the performance improvement grades associated with the similar workers in each of the at least one training programs. For example, the total or joint performance improvement grade may be evaluated, estimated or calculated by recommender engine 160. In some embodiments, a total or joint performance improvement grade per KPI may be evaluated, estimated or calculated, for each KPI. For example, the total or joint performance improvement grade may be calculated as a weighted average of the performance improvement grades of the similar workers, where the weights are the similarity scores.

In operation 260, a training program may be selected for the worker based on the performance improvement grades associated with the similar workers for the plurality of training programs, for example, by recommender engine 160.

For example, the training program k with the highest predicted total or joint performance improvement grade over q agents that are similar to agent j, normalized by the cost of training program k may be selected. For example, a training program may be selected by:

$$k = argmax ( k ) {\sum }_{i = 0}^{q} ( \frac{{KPI}_{ki} * {S}_{ij}}{cost of k * {\sum }_{i = 0}^{q} {S}_{ij}} ) ∀ {KPI}_{ki} <> None \qquad ( Equation 2 )$$

Where Sᵢⱼ are the similarity scores of agents i and j, KPIₖⱼ is the performance improvement grade of agent j in training program k, cost of k is the cost value associated with training program k. ∀ indicates ‘for’ and < > indicated ‘that is not’ or ‘that does not equal’, e.g., ‘∀ KPIₖᵢ< > None’ indicates that the calculation should include all the agents that have a performance improvement grade in training program k, and should not include agents that do not have a performance improvement grade in training program k. In case of a tie, the training program with the lowest cost may be picked, or an arbitrary training program may be selected from the training programs that got the same grade. argmax(k) returns the value of k (e.g., the training program number) at which the function values are maximized, and the sign ∀ indicates for or belongs to, e.g., the training program and other parameters related to a specific KPI. Other equations may be used for selecting the training program.

For example, consider agent #1 and agents #2-4 similar to agent #1 presented in table 2. The performance improvement grade for each of the training programs may be calculated by calculating a weighted average of the performance improvement of workers #2-4, weighted by the similarity score. The weighted averages may be normalized by the cost of each training program. In this example the cost of each training program equals the number of tasks in a training program. Thus, for example the cost for trivia is 1, and the cost for 1:1 and trivia is 2. Hence, the performance improvement grades for the training programs may equal:

performance improvement grade for 1:1=((0.9*1+0.8*2)/(0.9+0.8))/1=1.5%

performance improvement grade for trivia=((0.9*2+0.8*1)/(0.9+0.8))/1=1.5%

performance improvement grade for call listening=((0.9*1+0.8*0+0.6*0.1)/(0.9+0.8+0.6))/1=0.4%

performance improvement grade for 1:1, trivia=((0.9*3+0.8*3)/(0.9+0.8))/2=1.5%

performance improvement grade for 1:1, trivia, call listening=((0.9*4+0.8*3)/(0.9+0.8))/3=1.2%

The training program that provides the highest normalized performance improvement may be selected. In this example, three training programs received the highest normalized performance improvement grade, and a training program that includes 1:1 alone, and a training program that includes trivia alone, and a training program that includes 1:1 and trivia. In this case a training program with the lowest cost should be chosen. Since in this example the cost of each program equals the number of tasks in the training program, the cost of the training program that includes 1:1 alone, and the training program that includes trivia alone is 1 and the cost of the training program that includes 1:1 and trivia is 2. Thus, one of 1:1 alone or trivia alone should be selected. since both have the same cost, a program may be selected arbitrarily, by the system or by the supervisor.

Embodiments of the invention were tested using a simulation. To produce the data required for testing embodiments of the method disclosed herein, an agents' similarity matrix as shown in table 3 was generated. Agents were divided to clusters and similarity scores were provided based on the clusters. For example, pairs of two agents in the same cluster were provided with similarity score of 0.6-0.9, and pairs of two agents that were not in the same cluster were provided with similarity score of 0-0.4.

Each cluster was provided with an arbitrary cluster performance improvement grade, e.g., in the rage of 0-10%, for each training session. Consequently, each cluster was provided with a “best training program”, e.g., a training program that was given the highest performance improvement grade. Thus, for any given agent, if found to belong to a cluster, the correct recommended training program should be the “best training program” of that cluster. Each agent in a cluster was arbitrarily given a performance improvement grade that deviated, by for example ±2% from the cluster performance improvement grade. A 10-20% of the agent's performance improvement grades were left empty to allow a reasonable number of agents not attending all sorts of training programs.

Finally, an agent was chosen, and embodiments of the method were applied to the simulated data. Each turn represented 1,000 runs over data, where each run employs random numbers and results are combined. Three turns were performed. In the first turn the precision score equals the relative number of runs in which the training program that received the highest joint performance improvement grade was the “best training program”. In the second turn the precision score equals the relative number of runs in which one of the two training programs that received the highest or the second highest joint performance improvement grade was the “best training program”. In the third turn the precision score was equal to the relative number of runs in which one of the three training programs that got the three highest joint performance improvement grade was the “best training program”. Results are presented in table 4.

TABLE 4
Simulation results.

| Turn | Precision score |
|---|---|
| 1 | 0.82 |
| 2 | 0.92 |
| 3 | 0.96 |

In operation 270 the selected training program may be provided to or applied to the worker. For example, if a one-on-one session was selected, the worker may participate in a one-on-one session, if a trivia training program was selected, the trivia questioner may be provided to the worker, e.g., via agent devices 120.

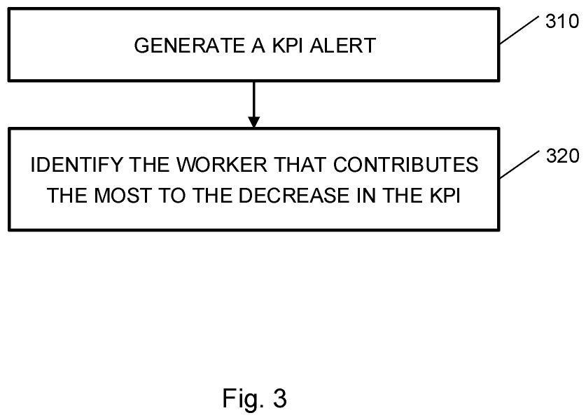

Reference is made to FIG. 3, which is a flowchart of a method for selecting a worker to be trained, according to embodiments of the invention. An embodiment of a method for selecting a worker may be an elaboration of operation 230 shown in FIG. 2, and may be performed, for example, by the systems shown in FIG. 1, but other hardware may be used.

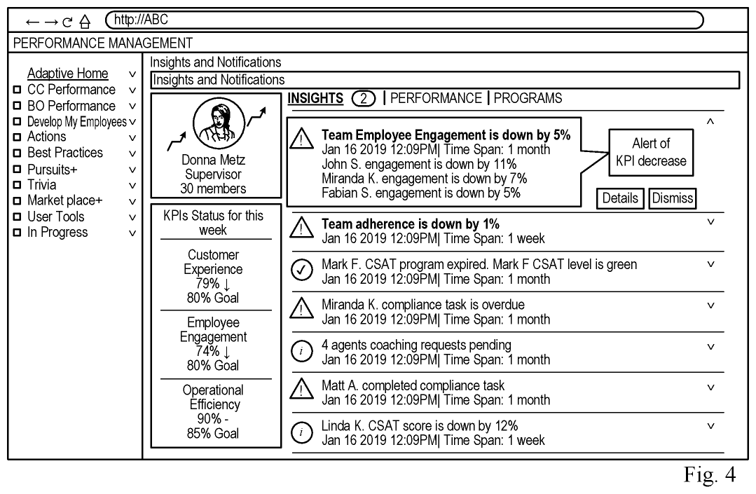

In operation 310, an alert may be generated in case of a decrease in a KPI in a group of workers. For example, the alert may be generated by e.g., contact center 124 or by other system. The alert may be obtained at recommender engine 160. In the screenshot example provided in FIG. 4, a supervisor name Donna Metz is receiving an executive report in a window called “Insights and Notifications”. The report warns her, e.g., provides an alert of KPI decrease, that a “Team Employee Engagement” KPI is down by 5% to a level of 74%.

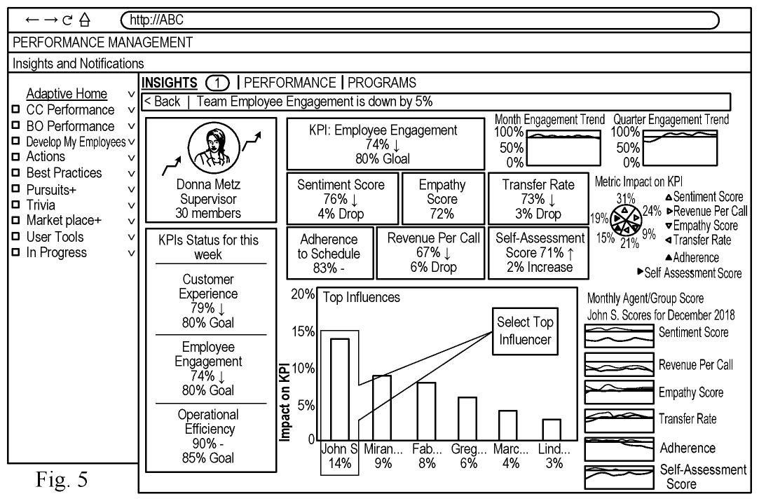

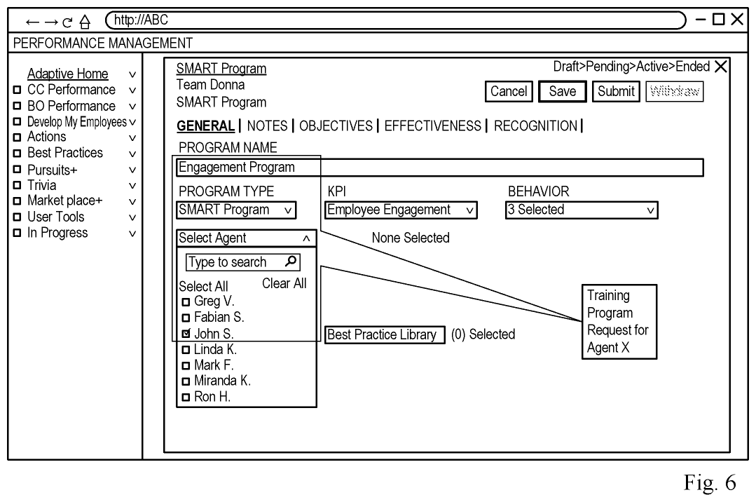

In operation 320, a worker may be selected. For example, the worker that contributes the most to the decrease in the KPI may be selected. The worker may be selected by contact center 124 or by recommender engine 160. The worker may be selected by drilling down to find root-cause for the decrease in KPI, e.g., finding the agent who has most of the impact for that decline. In some embodiments, the worker that contributes the most to the decrease in the KPI may be the agent with the highest decrease in that KPI and/or, the agent that is the farthest from his goal. In the screenshot example provided in FIG. 5, the agent named John Singer is the top influencer. In the screenshot example provided in FIG. 6, the supervisor requests that a training program would be selected for agent John Singer according to embodiments of the invention.

FIG. 7 illustrates an example computing device according to an embodiment of the invention. Various components such as supervisor devices 110, agent devices 120, contact center 124 and other modules, may be or include computing device 700, or may include components such as shown in FIG. 7. For example, a first computing device 700 with a first processor 705 may be used to select a training program from a plurality of training programs for a selected worker.

Computing device 700 may include a processor 705 that may be, for example, a central processing unit processor (CPU), a chip or any suitable computing or computational device, an operating system 715, a memory 720, a storage 730, input devices 735 and output devices 740. Processor 705 may be or include one or more processors, etc., co-located or distributed. Computing device 700 may be for example a workstation or personal computer located at a workplace or call center, or may be at least partially implemented by a remote server (e.g., in the “cloud”).

Operating system 715 may be or may include any code segment designed and/or configured to perform tasks involving coordination, scheduling, arbitration, supervising, controlling or otherwise managing operation of computing device 700, for example. Operating system 715 may be a commercial operating system. Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 may be or may include a plurality of, possibly different memory units.

Executable code 725 may be any executable code, e.g., an application, a program, a process, task or script. Executable code 725 may be executed by processor 705 possibly under control of operating system 715. For example, executable code 725 may be or include an application to select a training program for a worker. In some embodiments, more than one computing device 700 may be used. For example, a plurality of computing devices that include components similar to those included in computing device 700 may be connected to a network and used as a system.

Storage 730 may be or may include, for example, a hard disk drive, a floppy disk drive, a Compact Disk (CD) drive, a CD-Recordable (CD-R) drive, a universal serial bus (USB) device or other suitable removable and/or fixed storage unit. In some embodiments, some of the components shown in FIG. 7 may be omitted. For example, memory 720 may be a non-volatile memory having the storage capacity of storage 730. Accordingly, although shown as a separate component, storage 730 may be embedded or included in memory 720.

Input devices 735 may be or may include a mouse, a keyboard, a touch screen or pad or any suitable input device. It will be recognized that any suitable number of input devices may be operatively connected to computing device 700 as shown by block 735. Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a modem, printer or facsimile machine, a universal serial bus (USB) device or external hard drive may be included in input devices 735 and/or output devices 740. Network interface 750 may enable device 700 to communicate with one or more other computers or networks. For example, network interface 750 may include a WiFi or Bluetooth device or connection, a connection to an intranet or the internet, an antenna etc.

Embodiments described in this disclosure may include the use of a special purpose or general-purpose computer including various computer hardware or software modules, as discussed in greater detail below.

Embodiments within the scope of this disclosure also include computer-readable media, or non-transitory computer storage medium, for carrying or having computer-executable instructions or data structures stored thereon. The instructions when executed may cause the processor to carry out embodiments of the invention. Such computer-readable media, or computer storage medium, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computer” may be any computing system as previously defined herein, or any module or combination of modulates running on a computing system.

Computer database, systems integration, and scheduling technology may be improved by shortening the time taken to identify a person, retrieve records related to the person, and schedule a meeting with the person.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

The present disclosure is not to be limited in terms of the particular embodiments described in this application, which are intended as illustrations of various aspects. Many modifications and variations can be made without departing from its scope. Functionally equivalent methods and apparatuses within the scope of the disclosure, in addition to those enumerated, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used in this disclosure is for the purpose of describing particular embodiments only, and is not intended to be limiting.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

1. A method for selecting a training program from a plurality of training programs for a selected worker, the method comprising:
evaluating performance improvement of a plurality of workers who have taken training programs of the plurality of training programs, and associating a performance improvement grade to each of the workers for each of the training programs the worker has taken;
selecting, from a worker database, workers that are similar to the selected worker; and
selecting the training program for the selected worker based on the performance improvement grades associated with the similar workers for the plurality of training programs.

2. The method of claim 1, wherein evaluating performance improvement of a plurality of workers comprises:
for the plurality of workers:
providing at least one training program to a worker of the plurality of workers; and
for each of the at least one training programs, measuring performance of the worker before and after taking a provided training program, and calculating a performance improvement grade for the worker based on the performance measured before and after taking the provided training program.

3. The method of claim 1, wherein for a worker, the performance improvement grade associated with a training program is an improvement of a performance of the worker after taking the training program, relative to a performance of the worker before taking the training program.

4. The method of claim 1, wherein selecting the training program comprises:
calculating a total performance improvement grade for each of the at least one training programs, based on the performance improvement grades associated with the similar workers in each of the at least one training programs; and
selecting the training program with the maximal total performance improvement grade.

5. The method of claim 1, wherein selecting the training program comprises:
calculating a total performance improvement grade for each of the at least one training programs, based on the performance improvement grades associated with the similar workers in each of the at least one training programs;
associating a cost value with each training program;
normalizing the total performance improvement grade associated with each training program by the cost value of the training program; and
selecting the training program with the maximal normalized performance improvement grade associated with the similar workers.

6. The method of claim 1, comprising storing in the worker database a record for each worker, the record comprising a plurality of attributes of the worker.

7. The method of claim 6, wherein finding the similar workers in the worker database is performed based on the attributes of the workers.

8. The method of claim 1, wherein finding the similar workers in the worker database is performed by:
calculating a similarity score between the worker and other workers in the database; and
selecting workers with the highest similarity score.

9. The method of claim 8, wherein selecting the training program comprises:
calculating the total performance improvement grade for a training program of the at least one training programs as a weighted average of the performance improvement grades associated with the similar workers in the training program, wherein the weights are normalized similarity scores of the similar workers.

10. The method of claim 1, further comprising:
generating an alert in case of a decrease in a key performance indicator in a group of workers, wherein the selected worker is the worker that contributes the most to the decrease in the key performance indicator; and
providing the selected training program to the worker.

11. A system for selecting a training program from a plurality of training programs for a selected worker, the system comprising:
a memory comprising a worker database;
a processor configured to:
evaluate performance improvement of a plurality of workers who have taken training programs of the plurality of training programs, and associating a performance improvement grade to each of the workers for each of the training programs the worker has taken;
select, from the worker database, workers that are similar to the selected worker; and
select the training program for the selected worker based on the performance improvement grades associated with the similar workers for the plurality of training programs.

12. The system of claim 11, wherein the processor is configured to evaluate performance improvement of a plurality of workers by:
for the plurality of workers:
providing at least one training program to a worker of the plurality of workers; and
for each of the at least one training programs, measuring performance of the worker before and after taking a provided training program, and calculating a performance improvement grade for the worker based on the performance measured before and after taking the provided training program.

13. The system of claim 11, wherein for a worker, the performance improvement grade associated with a training program is an improvement of a performance of the worker after taking the training program, relative to a performance of the worker before taking the training program.

14. The system of claim 11, wherein the processor is configured to select the training program by:
calculating a total performance improvement grade for each of the at least one training programs, based on the performance improvement grades associated with the similar workers in each of the at least one training programs; and
selecting the training program with the maximal total performance improvement grade.

15. The system of claim 11, wherein the processor is configured to select the training program by:
calculating a total performance improvement grade for each of the at least one training programs, based on the performance improvement grades associated with the similar workers in each of the at least one training programs;
associating a cost value with each training program;
normalizing the total performance improvement grade associated with each training program by the cost value of the training program; and
selecting the training program with the maximal normalized performance improvement grade associated with the similar workers.

16. The system of claim 1, wherein the processor is configured to store in the worker database a record for each worker, the record comprising a plurality of attributes of the worker.

17. The system of claim 16, wherein the processor is configured to find the similar workers in the worker database based on the attributes of the workers.

18. The system of claim 11, wherein the processor is configured to find the similar workers in the worker database by:
calculating a similarity score between the worker and other workers in the database; and
selecting workers with the highest similarity score.

19. The system of claim 18, wherein the processor is configured to select the training program by:
calculating the total performance improvement grade for a training program of the at least one training programs as a weighted average of the performance improvement grades associated with the similar workers in the training program, wherein the weights are normalized similarity scores of the similar workers.

20. The system of claim 11, wherein the processor is configured to:
generate an alert in case of a decrease in a key performance indicator in a group of workers, wherein the selected worker is the worker that contributes the most to the decrease in the key performance indicator; and
provide the selected training program to the worker.
